(19) United States
(12) Patent Application Publication
(10) Pub. No.: US 2012/0170049 A1
(43) Pub. Date: Jul. 5, 2012

(54) Novel method and apparatus for 3-D scanning of translucent samples for radiation

(76) Inventor: Simon John Doran, Guildford (GB)

(21) Appl. No.: 13/374,626

(22) Filed: Jan. 4, 2012

Related U.S. Application Data
(60) Provisional application No. 61/460,527, filed on Jan. 4, 2011.

(51) Int. Cl. G01B 11/02

(52) U.S. Cl. 356/496

(57) ABSTRACT

The present invention discloses a device to measure optical properties of a three-dimensional translucent object, and a novel method to use the device to produce a valid, reproducible, and quantitative image of optical properties across the entire volume of the translucent object. The invention provides significant and useful improvements over existing practice. The invention provides a scanning instrument which eliminates the current practice of employing liquid refractive index matching solutions. The invention further provides a new method for reconstructing a three-dimensional image from light transmitted through the entire volume of a three-dimensional translucent object. This is accomplished by accounting explicitly for the bending of the light rays using an alternative method of reconstructing the images known as the Algebraic Reconstruction Technique.

### CROSS-REFERENCE TO RELATED APPLICATIONS

This application claims priority of U.S. Provisional Patent Application 61/460,527 filed on Jan. 4, 2011.

### STATEMENT REGARDING FEDERALLY SPONSORED RESEARCH OR DEVELOPMENT

Not Applicable

### REFERENCE TO A SEQUENCE LISTING

Not Applicable

### JOINT RESEARCH AGREEMENTS

Not Applicable.

### BACKGROUND OF THE INVENTION

### Field of the Invention

The invention relates to an improved optical scanning apparatus and method of use for the measurement of the three-dimensional distribution of optical properties within the volume of a translucent object. The invention is directed to the field of Optical Computed Tomography (CT) Dosimetry. The invention is particularly useful for, but not limited to, treatment planning, verification, and control in the field of medical radiotherapy. The invention advances the field of optical CT Dosimetry by providing an efficient scanning system, coupled with modified Algebraic Reconstruction Technique methods, which eliminates undesirable refractive index matching media and delivers three-dimensional images with reduced edge artifacts.

Several Optical CT scanning systems have been disclosed. In particular, the problem of scanning exposed dosimeters in order to evaluate medical radiotherapy plans has been addressed. For a recent review, see Doran et al J. Phys. Conf. Ser. 56 (2006) 45-57. Currently, commercially available Optical CT scanners, and most of those disclosed in the scientific and patent literature, designed for medical radiotherapy treatment planning, all incorporate refractive index (RI) matching media (vide infra) which imparts many undesirable aspects to these devices. Attempts to provide Optical CT scanners without RI matching media have been thus far inadequate and are not in current use. Optical CT has been utilized to produce computer-rendered images of various structures which permit the transmission of incident light. Optical CT allows the generation of three-dimensional images through tomographic reconstruction of a stepped series of two-dimensional data arrays (“slices”). Various techniques have been devised for the imaging of structures of various sizes, ranging from small (less than 1 mm field-of-view) to large (for example, a transparent cylinder having a radius of 10 cm).

One field in which optical CT has made an impact is the evaluation of the difference in optical properties within a three-dimensional translucent or transparent object. Three-dimensional dosimeters have been provided in which certain optical properties within the dosimeter volume change predictably upon interaction with ionizing radiation. These optical properties include degree of light scattering, absorbance, refractive index, and combinations of these. These three-dimensional dosimeters have found use in the evaluation of complex radiotherapy treatment plans such as Intensity-Modulated Radiation Therapy (IMRT), gamma knife radiotherapy, and three-dimensional conformal radiotherapy (3DCRT). In order to be useful, these three-dimensional dosimeters must be scanned to evaluate the optical data contained within. Optical CT scanners have been developed to meet this need. The Optical CT scanners all store in computer memory a series of two-dimensional images which are transformed by various algorithms and reconstructed into three-dimensional images by a computer program.

An Optical CT laser scanner for three dimensional dosimetry has been described (Gore et al, 1996, Physics in Medicine and Biology 41 2695-2704; U.S. Pat. No. 6,218,673 to Gore et al). The device disclosed employs a laser light source which is made to scan through a cylindrical dosimeter. The incident laser beam is reflected through 90 degrees by a first mirror and passed through the dosimeter contained within a RI matching RI medium. The transmitted beam is reflected through 90 degrees by a second mirror into a detector. A two-dimensional slice is produced by moving the first and second mirrors simultaneously along a carriage in a plane parallel to the optical axis. The dosimeter is rotated through a small angle in a plane orthogonal to the optical axis and another scan is measured. This scan and rotate process is repeated until the dosimeter has been rotated through 180 degrees. The entire volume of the dosimeter can only be scanned by employing a series of stepped rotations and axial translation of the dosimeter. Thus, after a large number of scans and stepped rotations of the dosimeter (180 scans when the step angle is set to 1 degree), the dosimeter must be indexed axially (e.g. so that the next scanned plane is 1 mm higher than the previous plane), and the scan-and-rotate process repeated. When the scanning is complete, a three-dimensional image is reconstructed after the data is subjected to filtration and back-projection algorithms. While this scanner has successfully evaluated several dosimeters, it suffers from a number of drawbacks which limit its usefulness. Transmission data requires correction to account for deviation of the laser beam from a normal incidence angle. The angle of incidence of the laser beam upon the surface of the tank was adjusted to 5 degrees from the window normal to reduce multiple reflections. The stepper-driven lateral mirror translation apparatus is vulnerable to error (precision motion of a relatively large structure is needed), resulting in a potential loss of resolution. The axial translation of the dosimeter required to measure slices perpendicular to the dosimeter axis represents another source of error. It is necessary to carefully align the center of the scan length with the axis of rotation of the dosimeter. The scanned area of each slice must be restricted to 90% of the diameter of the dosimeter. Errors in beam wandering across the face of the detector need to be compensated by the addition of a diffusing window and a converging lens. The most objectionable feature of this scanner is its long acquisition time. The total data acquisition time for a 60×60 pixel image was six minutes. Imaging of another object required approximately 2 seconds per profile, leading to an imaging time of about 12 minutes per slice. Total acquisition time for dosimeters of clinically relevant volume can exceed eighteen hours. True three-dimensional scans, with isotropic high resolution and a large field-of-view in the slice direction are not feasible using this methodology, particularly on a routine clinical basis. In addition, a bath of RI matching fluid is necessary to practice the invention.

Optical CT scanners employing area detectors have been developed. Scanners with Charge Coupled Device (CCD) or Complementary metal-oxide-semiconductor (CMOS) area detectors have become feasible with the widespread availability of high-quality digital cameras. Whereas laser systems acquire data in a point-by-point fashion, imaging area detectors allow the acquisition of a complete two-dimensional projection at once. Each two-dimensional projection gives the data required for creating a row in the sinogram for every slice in a three-dimensional reconstruction. Currently scientific CCD cameras have a typical matrix size of 1000.times.1000 pixels, so improvements of over two orders of magnitude in acquisition time over the Gore et al instrument (U.S. Pat. No. 6,218,673, vide supra) are theoretically possible. In practice, the speed when using a CCD-based system is often limited by the data-throughput rate, in particular the rate at which the data may be transferred out of the camera to the host computer. A disadvantage of the CCD system is its sensitivity to various types of artifacts. As opposed to the point illumination achievable with laser optical CT scanning, brightfield illumination utilized with CCD-based optical CT scanners can give rise to increased noise due to light scattering, stray light detection and, most significantly, differential refraction of incident light by regions of the sample with subtly different refractive indices (schlieren artifacts).

An optical CT scanner with a CCD area detector was disclosed (Bero, M. et al, 1999, DOSGEL 1999, 1st International Workshop on Radiation Therapy Gel Dosimetry, Kentucky). This scanner, based on parallel-beam geometry, utilized a LED light source with a lens arrangement to deliver parallel beams through a dosimeter immersed in refractive-index matching liquid. The dosimeter was rotated through a small discrete angle between the acquisitions of two-dimensional slices. The data was treated with filtration and back-projection algorithms and was reconstructed into a three-dimensional image.

A similar optical CT scanner employing cone-beam geometry was introduced (Wolodzko, J. et al, 1999, Medical Physics, 26 (11), 2508-2513), developed (Jordan, K. et al, 2001 DOSGEL 2001, Second International Conference on Radiotherapy Gel Dosimetry, Brisbane, 2001) and commercialized (Modus Medical Devices Inc., London, ON). This device also requires the utilization of RI matching fluid.

Recently optical CT scanners with laser light sources and improved acquisition times have been developed. The decrease in time required to scan an object relative to the Gore et al instrument (U.S. Pat. No. 6,218,673, vide supra) was achieved by adopting rotating mirrors to guide scanning in a raster fashion.

A scanner employing a single rotating mirror to scan laser light through a cylindrical sample was disclosed (Maryanski et al, 2001, Proc. SPIE, 4320, 764-774). This scanner was used for three-dimensional mapping of optical attenuation coefficient within translucent cylindrical objects. The scanner design utilized the cylindrical geometry of the imaged object to obtain the desired paths of the scanning light rays. A rotating mirror and a photodetector were placed at two opposite foci of the translucent cylinder that acts as a cylindrical lens. A laser beam passed first through a focusing lens and then was reflected by the rotating mirror, so as to scan the interior of the cylinder with focused and parallel paraxial rays that were subsequently collected by the photodetector to produce the projection data, as the cylinder rotates in small angle increments between projections. Filtered backprojection was then used to reconstruct planar distributions of optical attenuation coefficient in the cylinder. Multi-planar scans are used to obtain a complete three-dimensional tomographic reconstruction. The scanner was designed for use in radiation therapy dosimetry and quality assurance for mapping three-dimensional radiation dose distributions in various types of tissue-equivalent gel phantoms that change their optical attenuation coefficients in proportion to the absorbed radiation dose. This scanning system, in part due to the reliance upon the cylindrical shape of the gel dosimeter to function as a lens in the optical path, is able to scan only a fraction of the volume contained within the dosimeter, thereby limiting its usefulness. Moreover, the scanner uses only a single mirror, leading to deflection of the laser beam in only one dimension. Thus, to image multiple slices, the sample must again be translated axially, as for the original scanner of Gore et al (U.S. Pat. No. 6,218,673 vide supra). Motion of the mirror is uni-direction, rather than back and forth. This means that for a significant fraction of each cycle no useful data is being acquired. This limits the utility of the scanner.

An optical CT laser scanner employing a single rotating plane mirror has been described (van Doorn, T. et al, 2005, Australasian Physical Engineering Sciences in Medicine, 28, 76-85). In this scanner, laser light reflects from the rotating mirror and is directed to either a stationary plane mirror or to a first converging lens. When the light is directed to the stationary mirror, it is reflected into the detector for reference measurement. When the light beam is reflected from the rotating mirror into the acceptance aperture of the first lens, it is refracted to pass through an object immersed in a refractive index matching bath. The rotating mirror, mounted at the focal point of the first lens, directs the laser beam to scan a plane through the object, forming a set of parallel rays. A second converging lens refracts the light into the detector. Although the scanner was designed to have the capacity to form 1.0 mm.sup.3 voxels over the volume of a cylinder with a diameter of 100 mm and a height of 70 mm, the authors report a single reconstructed plane image produced from incremental stepped revolution of the object in 1.25 degree intervals, mirror rotation speed of 120 revolutions per second, and a total scan speed (one slice) of 2.4 seconds. Presumably the device will need to be altered to permit sampling of the entire volume of the object. This might be accomplished by advancing the object axially to scan consecutive planes through the object perpendicular to the object axis. Because the mirror rotates, it is inefficient in data acquisition in the same way as the scanner of Maryanski (vide supra).

An optical CT scanner comprised of a laser light source, a single rotating mirror, a lens pair, and a tilting yoke was disclosed (Conklin, J. et al, 2006, Journal of Physics Conference Series 56, 211-213). Two aspherical Fresnel lenses (200 mm focal length, 254 mm diameter, 8 grooves per mm) were placed on either side of an aquarium containing water into which the object to be scanned was placed. Two thin front surfaced mirrors were attached back to back to a steel cylinder attached directly to a small DC motor shaft. The rotating mirror assembly was mounted on a U shaped yoke that allowed the mirrors to tilt as well. The mirror assembly was positioned at the focal point of the input Fresnel lens. Stepper motors control mirror tilt and sample rotation. The tilting of the yoke allowed scanning of planes orthogonal to the axis of the dosimeter. Vertical beam stops at the aquarium edges provided start and stop reference positions. The photodiode detector was placed at the focal point of the exit Fresnel lens. The mirror rotated continuously at 10 Hz. The scanner algorithm involved recording a specified number of points after the signal exceeded a specified threshold followed by a mirror tilt. This sequence was repeated from top to bottom of the sample forming a raster scan. Next the sample was rotated and the raster scan was again repeated. Typical scan values: 1200 points per 150 mm, 200 projections per 180 degrees and 25 minutes per 75 slices. The samples were aqueous patent blue violet solutions and the cylinders were PFA Teflon tubes 96 mm OD and 0.5 mm wall thickness. Profile data points were converted from time to position by assuming a constant mirror rotation frequency and measuring the distance between the start and stop beam stops located at the aquarium edges. Poor resolution due to the use of Fresnel lenses and variability in motion control of the rotating mirror and tilting yoke limits the usefulness of this technique.

Doran et al (U.S. Pat. No. 7,633,048) disclosed scanning devices which measure and quantify optical properties within an object such as the absorption of light, refractive index, light scattering, fluorescence, and phosphorescence. Through the use of two rotating plane mirrors and two paraboloid mirrors, a laser light beam was made to traverse the object to be scanned wherein the beam was always parallel to the optical axis. The invention provided an improvement over previously reported scanning devices by virtue of increased speed and resolution. Two-dimensional projections gleaned by each scan of the object were reconstructed into a three-dimensional image through the use of various computer techniques. Although an improvement over previous OCT scanners, this invention shared the disadvantage of requiring RI matching liquid.

With the exception of two instruments (described in more detail below), all optical CT scanners so far presented have placed the sample inside a tank filled with refractive index matching fluid, i.e., fluid whose refractive index is the same as or extremely close to that of the sample itself. This is to overcome a significant technical challenge in optical CT, namely that, at the boundaries between optical media of different refractive indices, light is refracted. The standard optical CT reconstruction method, known as filtered back-projection requires that this refraction be minimised or, preferably, eliminated completely. Among the several deficiencies and drawbacks associated with the use of RI matching media is the requirement that the refractive index of the matching media is adjusted to be substantially the same as that of the object being scanned. Optical CT scanners with no matching media have been disclosed. Wuu et al (Medical Physics, 2003. 30 (2) 132-137) disclosed a OCT scanner which did not employ RI matching fluid (FIG. 3). It differs from the present invention in two important respects. (a) A large part of the object is not scanned. Quoting from the paper “The scanning light rays are confined within ⅓ of the cylinder diameter so that the optical aberration of the cylinder can be safely neglected”: i.e., refraction is ignored rather than utilised. (b) The scanner uses filtered back-projection for data reconstruction, rather than ART.

Papadakis et al (Medical Imaging, IEEE Transactions on, 2010. 29 (5) 1204-1212) disclosed a scanner. It differs from the present invention because no attempt is made by the authors to account for deviations of the light paths by refraction. The default mode of operation is with matching liquid, but the authors show that the system can operate without the matching liquid, with images being reconstructed using standard filtered back-projection. However, these images contain severe imaging artefacts caused by the optical refraction that they are ignoring and are not adequate as a basis for quantitative radiation

dosimetry

### BRIEF SUMMARY OF THE INVENTION

The present invention discloses a device to measure optical properties of a three-dimensional translucent object, and a novel method to use the device to produce a valid, reproducible, and quantitative image of optical properties across the entire volume of the translucent object. The invention provides significant and useful improvements over existing practice. The invention provides a scanning instrument which eliminates the current practice of employing liquid refractive index matching solutions. The invention further provides a new method for reconstructing a three-dimensional image from light transmitted through the entire volume of a three-dimensional translucent object. This is accomplished by accounting explicitly for the bending of the light rays using an alternative method of reconstructing the images known as the Algebraic Reconstruction Technique (ART).

### BRIEF DESCRIPTION OF THE DRAWINGS

FIG. 1 (Simulation) depicts graphically the phenomenon of aberration of light rays passing through a translucent three-dimensional object with optical data contained within. FIG. 1a shows the significant aberration which occurs in scanners currently utilized if no attempt is made to minimize the difference in refractive index at the boundary of the scanned object. FIG. 1b delineates the ideal but unattainable situation where there is a continuum of refractive index at the interface of the scanned object and an ideal RI matching solution, resulting in the lack of aberration of transmitted light. In FIG. 1c, a realistic situation under current practice is portrayed, wherein an RI matching solution with refractive index very close to, but not equal to, that of the scanned object is employed. FIG. 1c demonstrates the problem of aberration which the present invention addresses. FIGS. 1d through 1f delineate the transmitted light pattern detected.

FIG. 2 (Four Scanner Designs) illustrates the schematic array of optical elements in optical scanners currently in use for comparison to the present invention.

FIG. 3 (Dry Scanner Wuu) depicts the scanner disclosed by Wuu et al (Medical Physics, 2003. 30 (2) 132-137) for comparison to the present invention

FIG. 4 (Scanner Papadakis et al) depicts the scanner disclosed by Papadakis et al (Medical Imaging, IEEE Transactions on, 2010. 29 (5) 1204-1212) for comparison to the present invention.

FIG. 5 (Scanner Examples) depicts several non-limiting embodiments of the present invention in which no RI matching media are employed.

FIG. 6 (a, Simulation; b, Difference between Original and Reconstructed Data) sets out the initial results of using the methods of the invention. FIG. 6a represents the “digital phantom” utilized to garner the data and FIG. 6b shows the reconstructed image.

FIG. 7 (Component Detail) delineates details of the components of one embodiment of the invention.

FIG. 8 (Experimental Data Acquisition) shows data acquired utilizing the embodiment of the invention depicted in FIG. 7.

### DETAILED DESCRIPTION OF THE INVENTION

The present invention is directed to the field of Optical Computed Tomography (CT) dosimetry. Dosimetric devices, or dosimeters, are objects which, after the absorption of radiation, change in a predictable, measurable and quantifiable way as a direct result of the dose of radiation which had been absorbed by the object. In Optical CT dosimetry, liquid, gel, and solid translucent polymeric dosimeters have been fabricated to contain one or more reporter molecules which have been designed to predictably change one or more physicochemical parameter possessed by the reporter molecule upon absorption of radiation. This is akin to the classical photographic process wherein the interaction of silver halide embedded or attached to the surface of a film undergoes a physical change upon absorption of visible light. In Optical CT dosimetry, the optimal dosimeter is a translucent three-dimensional object within which is uniformly distributed a reporter molecule which possesses an optical property which predictably changes upon the absorption of radiation. A non-limiting example of such a dosimeter was disclosed (US Publ. Pat. Appn. 2007/0020793 to Adamovics) wherein a transparent cylindrical polycarbonate object, within which was uniformly distributed a colorless Ieucodye, efficiently mapped the absorption of an applied radiation field due to the transformation of the Ieucodye to a colored species in irradiated domains. The invention provides a device which makes non-invasive, quantitative, and precise measurements of optical properties across the three-dimensional volume of objects which transmit light. The invention is directed to devices which measure and quantify optical properties which include, but are not limited to, absorption of visible light, absorption of ultraviolet light, absorption of infrared light, refractive index, light scattering, fluorescence, phosphorescence, and combinations of these. In one non-limiting embodiment, the invention is used to quantify the three-dimensional distribution of a radiation dose absorbed by an object in which optical properties of the object have been made to change predictably with the interaction with ionizing radiation. In one embodiment, the invention allows the planning and execution of a radiotherapy treatment to be simulated, measured, and evaluated on an inanimate object before applying it to humans and is particularly important for validating complex radiotherapy treatment plans. Without such an experimental measurement, it is impossible to be sure that the dose received by a patient is that predicted by the treatment planning software. In this application, the invention provides information by measuring the optical attenuation coefficient (also commonly referred to as optical density) of the sample at all points in the three-dimensional volume. The object is specially designed so that its optical properties (in particular, its absorption or scattering coefficients at the wavelength of operation of the system) change with the absorption of radiation in a predictable and quantitative manner.

The present invention is directed to the improvement of existing technology for measuring ionizing radiation fields. Such radiation fields are in common use in medical radiology, medical radiotherapy, manufacturing and energy production. The monitoring of radiation levels is critical for planned or inadvertent exposure of all life forms to gamma rays, X-rays, cosmic rays, proton, carbon and other ion beams, and other forms of ionizing radiation. In general, embodiments of the invention are useful in the measurement of inadvertent exposure (a non-limiting example is dosimetry badges employed by medical researchers and diagnosticians), measurement of radiation levels in areas with high probability of radiation contamination (non-limiting examples are dosimetry at nuclear facilities for calibration, quality control, and decommissioning purposes and dosimetry mandated by military or Homeland Security officials), and measurements of radiation fields for the planned therapeutic radiation of patients as part of a treatment regimen.

In one embodiment of the present invention, non-invasive, quantitative, three-dimensional measurements of the radiation dose absorbed by a dosimetric object are made. The measurement process is comprised of subjecting the dosimetric object to a field or fields of radiation; removing the object from the fields of radiation; placing the object in the scanner of the present invention; scanning the object with light rays and detecting the spatial and intensity aspects of the transmitted light in a three-dimensional array by methods disclosed herein; calculating a three-dimensional image by methods disclosed herein whereby the image represents a true, accurate, and quantitative depiction of the original radiation fields. This allows the process of radiotherapy treatment to be simulated on an inanimate object before applying it to humans and is particularly important for validating complex radiotherapy treatment plans. This planning method is invaluable to caregivers who must plan with as little error as possible the intensity and distribution of therapeutic doses of radiation. It is critical in radiotherapeutic treatment to deliver the appropriate dose to diseased tissues while avoiding irradiation of healthy tissue nearby. In addition, without such an experimental measurement, it is impossible to be sure that the dose received by a patient is that predicted by treatment planning techniques, and is appropriate for chronic or long-term radiotherapy treatment.

The method and device described herein fall within the general area of optical computed tomography (CT), which is one of several different methods of imaging (the others being Magnetic Resonance Imaging, x-ray CT and ultrasound imaging). Optical CT is particularly advantageous because (i) data acquisition is exceedingly rapid; (ii) the scanners can be made relatively cheaply; and (iii) the scanners are small enough to be accommodated easily in a radiotherapy physics department.

In one embodiment, the scanner of the present invention, and the method of image reconstruction of the invention, are used with cylindrical previously irradiated three-dimensional dosimeters. The dosimeter, or three-dimensional object, is designed so that its optical properties (in particular, its absorption or scattering coefficients at the wavelength of operation of the system) change with the absorption of radiation in a predictable and quantitative manner. The purpose of the scanner is to measure these optical properties non-invasively at all points in a specified 3-D volume and thus to deduce the dose which had been absorbed by the object.

It is an object of the invention to provide a scanning device which facilitates the transmission of light through a translucent three-dimensional object, the optical properties of said object having been previously altered by interaction with radiation, and said transmission captured by one or more optical detectors, wherein said capture is in the form of digital data stored on computer media, wherein said data is converted by means of the invention to a valid, reproducible, and quantitative three-dimensional image truly representing the said altered optical properties, wherein said transmission and said image encompass the entire volume of said object.

It is another object of the invention to provide such a scanning device wherein no means to eliminate or mitigate or reduce the difference in refractive index of the object to be scanned and its surroundings are employed.

It is another object of the invention to provide a scanner with no refractive index capability which produces a valid, reproducible, and quantitative image through scanning of the entire volume of a three-dimensional dosimeter for the purposes of planning, mapping, predicting, or verifying radiotherapy for medical treatment purposes, wherein the method of calculation used to produce such an image are substantially those disclosed herein.

It is another object of the invention to provide a scanner with no refractive index matching capability which produces a valid, reproducible, and quantitative image through scanning of the entire volume of a three-dimensional dosimeter for the purposes of planning, mapping, predicting, or verifying the irradiation fields in the productive and peaceful use of ionizing radiation, wherein the method of calculation used to produce such an image are substantially those disclosed herein.

It is still another object of the invention to provide a scanner with no refractive index matching capability which produces a valid, reproducible, and quantitative image through scanning of the entire volume of a three-dimensional dosimeter for the purposes of detecting, measuring, mapping, or quantifying ionizing radiation, wherein the calculations used to produce such an image are substantially those disclosed herein.

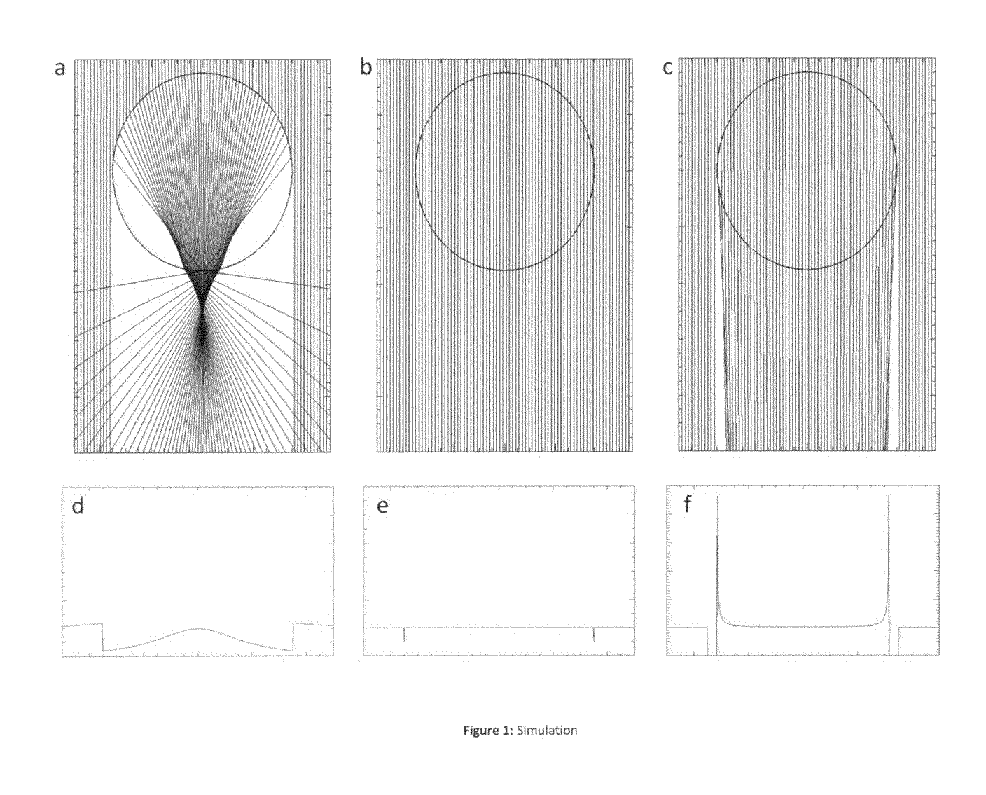

FIG. 1 shows a set of simulations to illustrate the effect. Parallel light rays are emitted by a source at the top of the image, and are refracted at both the entry and exit of a uniform cylindrical sample of refractive index 1.5, such as might be used in optical CT. FIG. 1a shows the case in which no matching fluid is present outside the sample and there is clearly a very significant effect. FIG. 1b is the case of an ideal index matching fluid, for which no deviation of light rays occurs. FIG. 1c shows a situation that is typical of what occurs in practice, in which a small (0.3%) difference in refractive index results in a slight bending of beams at the edge of the phantom. FIGS. 1d-f show the light intensity as would be measured at an observation plane at the bottom of FIGS. 1a-c by a typical parallel-beam, camera-based (CCD) scanner. FIG. 1e represents the ideal case, where the intensity is uniform, whereas FIG. 1d, with no matching fluid, shows significant perturbations of the ideal intensity and it would not be at all easy to reconstruct a valid image from these data by standard methods. In FIG. 1f, valid data can be reconstructed in the centre of the sample, but there is a large edge artifact and no valid information can be obtained from approximately the outer 20% of the sample.

There are several important reasons why modifying the scanner design and image reconstruction method to obviate the need for a matching medium would be beneficial. (i) As shown above, in realistic cases, the matching is never completely effective. (ii) The use of a matching tank makes the scanning procedure slower and more complicated (both because it is slower to load and retrieve samples, and because the presence of the liquid limits the rate at which the sample can turn during tomographic scanning); (iii) the liquid is messy and can contaminate other parts of the apparatus; (iv) the presence of matching liquid reduces the quality of the data (for example, motes of dust float around in it and are seen on the scans); matching liquid may present safety issues to scanner operators; (v) spent or contaminated matching liquid must be disposed as hazardous waste.

Even with good matching, data is still lost from the outermost region of the sample. Typically, poor-quality readings are obtained from 10-20% of the sample volume, due to the edge effects shown in FIGS. 1c and f.

It is not possible to obtain a refractive index-matching fluid for all possible samples due to the limited range of fluid RI's.

It can be very time-consuming to obtain the excellent correspondence required between the refractive indices of the fluid and the dosimeter. This is normally achieved by mixing two liquids whose refractive indices bracket that of I of the dosimeter. Since the latter is often not known accurately, there is often a process of trial and error, mixing the two liquids in different proportions until a suitable match is achieved. This process may take several hours for the large volumes of fluid (>5 L) that are used in the measurement of radiotherapy test objects.

The refractive index matching phenomenon is temperature dependent. This means, for example, that a matching tank optimised for a sample at room temperature will not function correctly if the sample has been stored in the refrigerator. This leads to significant time penalties in scanning, while the user waits for temperature equilibration.

The refractive index-matching liquid supports thermal convection currents, leading to “swirls” of altered RI, which disrupt the images.

The refractive index-matching liquid introduces additional optical scatter, which degrades the quality of the images.

Without operating the equipment in a “clean room” type environment, it is very difficult to remove all motes of dust and other airborne contamination from the matching liquid. These are easily seen in the sample and cause artifacts in the reconstructed images. A key part of the scanning procedure is rotation of the sample. Ideally, this would be rapid, to reduce scan times. However, when using an RI-matching liquid, this rotation rate is limited, because fluid drag causes vortices and other motions of the liquid and these lead to significant artefacts in the optical CT images.

Use of the matching tank is cumbersome. Filling the tank, loading the samples, drying the samples after use, and keeping the work area clean are all tasks that reduce significantly the throughput of the optical CT scanner.

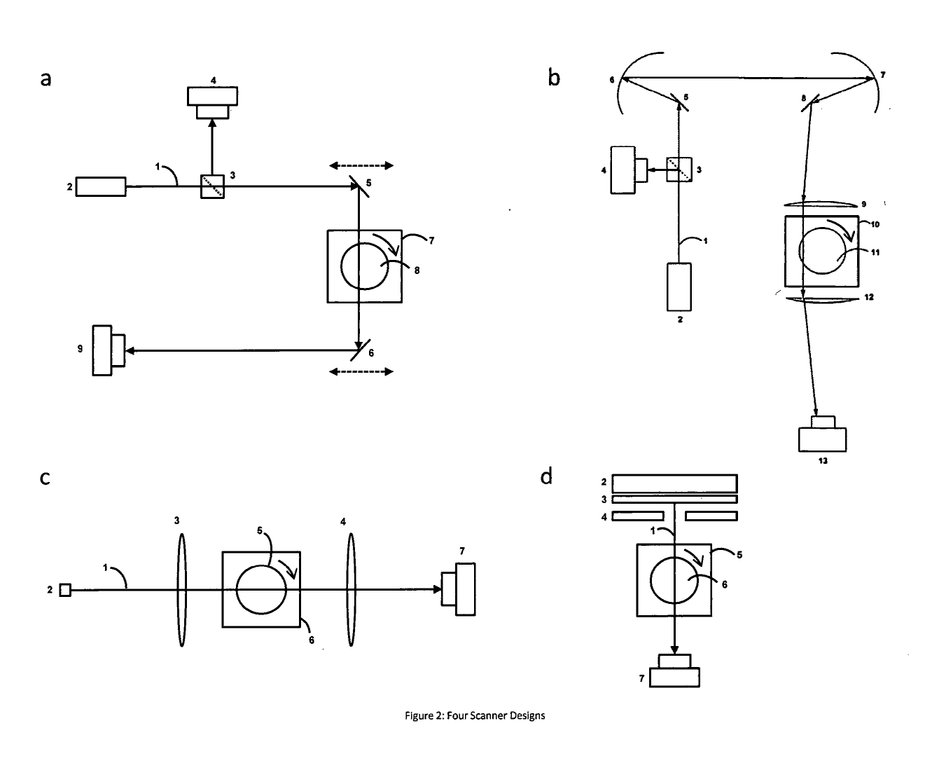

Four classes of CCD scanner have so far been presented in the gel dosimetry literature and are illustrated in FIG. 2.

The first-generation laser scanner (FIG. 2a) was introduced by Gore [2] in 1996 and is now marketed by MGS Research. A laser beam (1) is emitted from a laser (2) and passes through a beam splitter (3). Part of the beam is measured by a reference detector (4), whilst the rest is reflected from movable mirrors (5 and 6) and passes through a tank filled with matching liquid (7), in which a sample (8) sits on a rotation table, before being measured by a second detector (9).

Several faster laser variants are now available, including the scanning laser device introduced in 2007 [3] and disclosed in U.S. Pat. No. 7,633,048 (FIG. 2b). Here, a laser beam (1) is emitted from a laser (2) and passes through a beam splitter (3). Part of the beam is measured by a reference detector (4), whilst the rest is reflected from galvonometer mirrors (5 and 8) and curved mirrors (6 and 7), passes through lenses (9 and 12), a tank filled with matching liquid (10), in which a sample (11) sits on a rotation table, and is finally measured by a second detector (13).

Devices based on cameras with pixelated detectors, such as charge-coupled devices (CCD's), have also been presented. These include parallel-beam scanners (FIG. 2c) [4], in which a beam of light (1) is emitted from a light source (2) and passes through lenses (3 and 4) and the sample (5) on a rotation stage within a tank filled with matching liquid (6), before being detected by a CCD camera (7); and those based on the cone-beam (FIG. 2d) geometry [5] [6], as sold commercially by Modus Medical Devices Inc. under the trade name Vista™. The latter consist typically of a broad light beam (1) from an extended light source (2), passed through a diffuser (3) and collimator (4). The light passes through a tank filled with matching liquid, in which a sample (6), sits on a rotation stage.

In each case, data are reconstructed using a computational technique known as filtered back-projection. All of these scanners currently use matching liquid, but, in principle devices depicted in FIGS. 2a-c could all be modified using the current invention to work without a matching tank, thus rendering them much simpler pieces of apparatus to construct and operate.

The invention is to remove the matching tank from the optical CT apparatus and to account explicitly for the bending of the light rays using an alternative method of reconstructing the images known as the Algebraic Reconstruction Technique.

The two key features of the invention are:

a mechanism for acquiring appropriate data without using a matching tank (apparatus modification);

a method of image reconstruction, that can handle data from raypaths that have been bent by refraction. In the implementation proposed, the method calculates explicitly what those paths are and incorporates them into an existing algorithm known the Algebraic Reconstruction Technique (ART).

To the best of the applicant's knowledge, these two components have not been used in this fashion before in the field of 3-D radiation dosimetry nor in optical CT.

Two teams have previously have considered the possibility of an optical CT scanner for radiotherapy that works without a matching tank, but these have not have not used this combination of technology and have not been completely successful. Prior work includes the following:

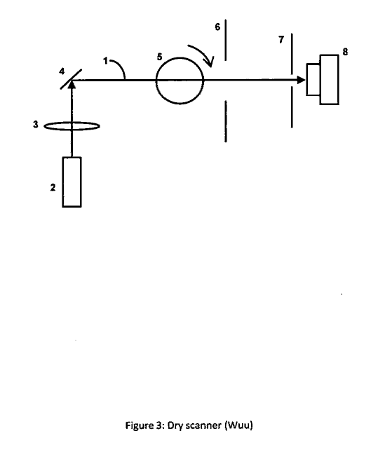

Wuu, C. S., Schiff, P., Maryanski, M. J., Liu, T., Borzillary, S., and Weinberger, J., Dosimetry study of Re-188 liquid balloon for intravascular brachytherapy using polymer gel dosimeters and laser-beam optical CT scanner. Medical Physics, 2003. 30 (2) 132-137. The design of this instrument is illustrated in FIG. 3, in which a laser beam (1) originating from a laser (2) passes through a converging lens (3), is deflected by a rotating mirror (4) and passes through a sample (5) and two collimating apertures (6 and 7), before being measured by a photodetector. It differs from the present invention in two important respects. (a) A large part of the object is not scanned. Quoting from the paper “The scanning light rays are confined within 1/3 of the cylinder diameter so that the optical aberration of the cylinder can be safely neglected”: i.e., refraction is ignored rather than utilized. (b) The scanner uses filtered back-projection for data reconstruction, rather than ART.

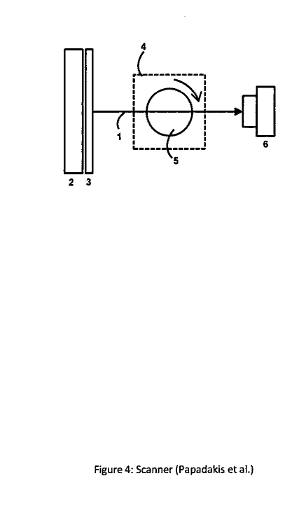

Papadakis, A. E., Zacharakis, G., Maris, T. G., Ripoll, J., and Damilakis, J., A New Optical-CT Apparatus for 3-D Radiotherapy Dosimetry: Is Free Space Scanning Feasible? Medical Imaging, IEEE Transactions on, 2010. 29 (5) 1204-1212.The design of this instrument is illustrated in FIG. 4, in which a broad beam of light, originating in an extended light source (2) and a diffuser (3), passes through an optional tank filled with matching fluid (4) and the sample (5), before being measured by a CCD camera. It differs from the present invention because no attempt is made by the authors to account for deviations of the light paths by refraction. The default mode of operation is with matching liquid, but the authors show that images can be reconstructed with no matching liquid using standard filtered back-projection. However, these images contain severe imaging artifacts caused by the optical refraction that they are ignoring.

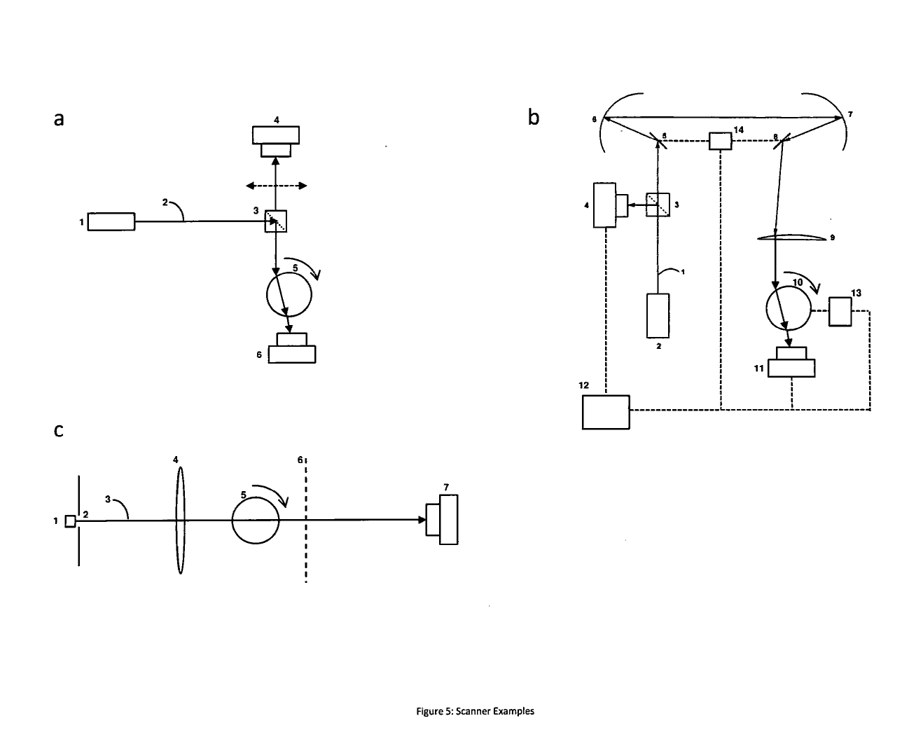

FIG. 5 shows three non-limiting examples of the present invention, reflecting possible implementations of the principles embodied by the invention. These designs show how the new principles are applied to substitute for the scanning tank in arrangements that correspond to the previous designs in FIGS. 2a-c.

### EXAMPLE 1

FIG. 5a. A radiochromic sample is placed on a turntable (not shown) attached to a rotational stepper motor. The laser (1) produces a beam (2) which is directed onto a beam splitter (3). The intensity of the laser beam reaching the reference photodetector (4) is recorded. The beam passes through the sample (5) and the transmitted signal is then measured by a second photo detector (6). The laser beam is translated laterally across the sample using a second stepper motor and the measured signal is synchronised with the position of the laser beam in such a way that a 1-D data array (projection) can be recorded. For each laser beam position, the path through the sample is calculated explicitly, using standard equations of refraction. The rotation angle of the turntable is incremented and the scan of the laser is repeated to create a second projection. The whole process is repeated until a predefined number of projections have been acquired. These data are now sufficient to reconstruct a 2-D map of optical density using ART, which is the desired outcome of the measurement.

### EXAMPLE 2

FIG. 5b. A radiochromic sample is placed on a turntable (not shown) attached to a rotational stepper motor. The laser beam (1) from laser (2) is directed onto a beam splitter (3). The intensity of the laser beam reaching the reference photodetector (4) is recorded. The portion of the laser beam transmitted by the beam splitter impinges on galvo mirror (5), parabolic mirrors (6 and 7) and galvo mirror (8) and thence passes through the lens (9). These optical components have the net effect of translating the laser beam across the sample both laterally and in the plane perpendicular to the diagram in a manner that is dependent on the angulation of the two galvo mirrors. The beam passes through the sample (10) and the transmitted signal is then measured by photo detector (11). A computer (12) controls the sample rotation via rotational stage controller (13) and mirror position via galvanometer driver (14). For each laser beam position, the path through the sample is calculated explicitly, using standard equations of refraction. The rotation angle of the turntable is incremented and the scan of the laser is repeated to create a second projection. The whole process is repeated until a predefined number of projections have been acquired. These data are now sufficient to reconstruct a 2-D map of optical density using ART, which is the desired outcome of the measurement.

### EXAMPLE 3

FIG. 5c. A radiochromic sample (5) is placed on a turntable (not shown) attached to a rotational stepper motor (not shown). Light from an LED (1) is passed through a pinhole (2) to create a pseudo point source. The light transmitted by the pinhole is collimated into a parallel beam by a converging lens (4) and then passes through the sample. Inside the sample, light is refracted. The refracted light distribution at the focal plane (6) is captured by a custom lens arrangement (e.g., a telecentric lens combination) and an image is formed on a charge coupled device (CCD) pixelated array (7). For each raypath contributing to the projection image so formed, the path through the sample of each contributing ray is calculated explicitly, using standard equations of refraction. The rotation angle of the turntable is incremented and the scan of the laser is repeated to create a second projection. The whole process is repeated until a predefined number of projections have been acquired. These data are now sufficient to reconstruct a 2-D map of optical density using ART, which is the desired outcome of the measurement.

The target data which is reconstructed by the method of the invention is a 2-D array of optical density values, which (without loss of generality) are represented by a square N×N matrix.

The Beer-Lambert law of optical absorption is:

$$R = ln ( \frac{I}{{I}_{0}} ) = - {\int }_{optical path}^{ } μ ( y ) d y$$

where I is the signal intensity measured by the relevant detector after light of initial intensity I₀ has passed along the given path. If we now move to modelling the situation using discrete variables, rather than integrals, we have a linear problem in which the output signal Sᵣ from light that has travelled along a specified ray path (labelled by index r) is a linear combination of the p values for the voxels in the sample. For samples of certain simple shapes, such as the cylinders and spherical objects often scanned in optical CT, it is appropriate to assume that all the optical paths associated with a given reconstructed axial slice involve only the p values for the voxels within that slice.

A single projection P_{□} is a set of n_{ray} attenuation values (line integrals), corresponding to all the ray paths used in the experiment, with the sample at a given rotation angle □. The complete experimental data S for a single slice image corresponds to the set of all nₚᵣₒⱼ acquired projections, with the sample rotated between projections over a range of different □. In traditional back-projection, the complete raw dataset, suitably arranged in the form of an n_{ray}×nₚᵣₒⱼ matrix, is known as the sinogram. When referring to a general matrix element, the notation Sᵣₚ is used, where r represents the ray number and p the projection number.

The basis of all ART methods is a forward model that relates a given measurement (line integral) Sᵣₚ to a linear combination of attenuation values of sample pixels. The sinogram data are given by

$${S}_{rp} = {\sum }_{i = 1}^{{n}_{x}} {\sum }_{j = 1}^{{n}_{y}} {w}_{ijrp} {μ}_{ij} ,$$

where i and j are the coordinates of a pixel in the sample, μᵢⱼ is the optical density of the pixelon a grid of dimension nₓ×n_{y}, and wᵢⱼᵣₚ is a weighting factor indicating the contribution that pixel (i, j) makes to the signal Sᵣₚ (Andersen A H 1989 Algebraic reconstruction in CT from limited views IEEE Trans. Med. Imaging 8 50-5).

Early implementations of ART were hindered by the limited computing resources of the times and tended to set w as either 1 or 0, depending on whether ray r passed through pixel (i, j) or not. This led to noisy reconstructions. A much better forward mode sets the contribution of a given value μᵢⱼ to the total attenuation of the signal Sᵣₚ as equal to the fraction of the pixel occupied by the r^{th} ray, which is bounded by the lines yᵣ(x) and yᵣ₊₁(x). The required weighting is

wᵢⱼᵣₚ=∫ₓᵢ^{x}_{ᵢ₊₁}Le[yᵣ₊₁(x),yᵢ₊₁]−Gt[yᵣ(x),yᵢ]dx, [2]

where the function Le returns the lesser of its two arguments and Gt returns the greater.

One non-limiting implementation of the method involves Simultaneous Algebraic Reconstruction Technique (SART) variant of ART to perform the reconstruction(Andersen, 1989). The pseudo-code for this algorithm is as follows:

| ${\tilde{μ}}^{( 0 )} = \{ \begin{matrix}1.0 & inside phantom \text{-} sized circle \\ 0.0 & outside circle\end{matrix}$ ∀r,p \tilde{S}ᵣₚ⁽⁰⁾ = Σᵢⱼ wᵢⱼᵣₚ\tilde{μ}ᵢⱼ⁽⁰⁾ for q = 1 to nᵢₜₑᵣ do | | | | Initialize estimated result matrix \tilde{μ}⁽⁰⁾ to a uniform circle of the same size as the phantom, filled with the value 1.0. Outside the circle, set the elements of \tilde{μ}⁽⁰⁾ to zero. Calculaate the initial estimated sinogram \tilde{S}⁽⁰⁾ using Eq. [1]. |
|---|---|---|---|---|
| | for p = 1 to nₚᵣₒⱼ do ∀r,p Dᵣₚ := \tilde{S}ᵣₚ^{(q-1)} − Sᵣₚ ∀i,j Cᵢⱼ := 0 | | | Repeat the whole process for a number of iterations. This might be fixed, or might continue until some defined level of convergence has been achieved. |
| | | for r = 0 to n_{ray} do | | Loop over all the projections. |
| | | | ∀i,j Cᵢⱼ := Cᵢⱼ + [wᵢⱼᵣₚDᵣₚ]/Σᵢⱼwᵢⱼᵣₚ | |
| | | end for ∀_{i,j} \tilde{μ}ᵢⱼ^{(q)} := \tilde{μ}ᵢⱼ^{(q-1)} + λ Cᵢⱼ/Σᵣwᵢⱼᵣₚ | | Calculate the difference between the previous estimated sinogram and the true (measured) sinogram Initialise term (2-D matrix) to zero. |
| | end for | | | Loop over all rays in a given |
| | | | | projection. |
| | | ∀r,p \tilde{S}ᵣₚ^{(q)} = Σᵢⱼ wᵢⱼᵣₚ\tilde{μ}ᵢⱼ^{(q)} | | Take the difference between the |
| | | | | estimated projection value for |
| | | | | this ray and the true result and |
| | | | | spread it out over all the pixels |
| | | | | that contribute to the result, |
| | | | | with appropriate weighting. |
| end for | | | | |
| | | | | Update the estimated result |
| | | | | matrix. Each of the corrections |
| | | | | Cᵢⱼ needs to be normalised by |
| | | | | the total of the weighting over |
| | | | | all rays and, in addition, we |
| | | | | use a “relaxation” factor λ to |
| | | | | “moderate” the changes. This |
| | | | | leads to slower con-vergence |
| | | | | but, potentially a more accurate |
| | | | | result. |
| | | | | Update the estimated sinogram. |

### Sample Result

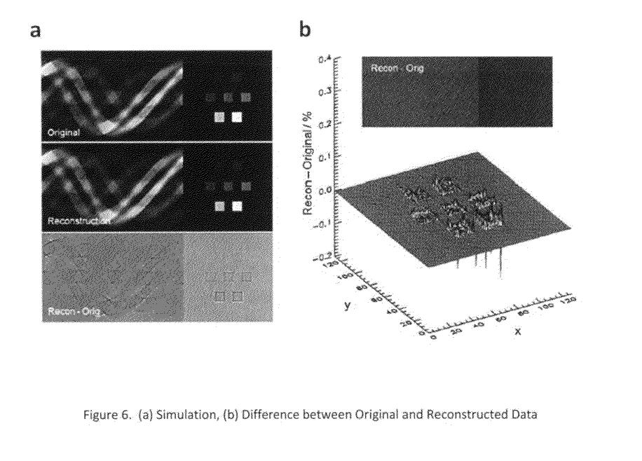

FIG. 6 illustrates a reconstructed image using the methods of the invention for a “digital phantom” of dimension 128×128, with 202 projections.

### Constructed Embodiment of Invention

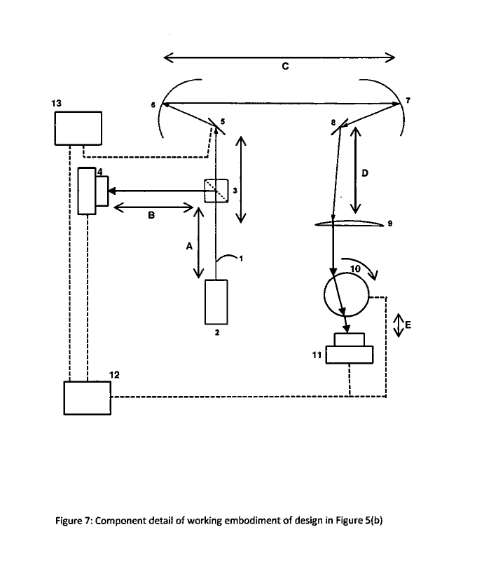

In one embodiment, the device of the invention is achieved by assembling all the separate components in the schematic diagrams on an optical bench, at carefully determined distances. An appropriate calibration procedure is necessary. As seen in FIG. 7, precisely defined components are assembled: laser beam (1) from laser Melles-Griot 25-LHP-121-230, 2 mW, 0.59 mm beam diameter, 633 nm (2); beam-splitter (3); large area photoreceiver, 8 mm diameter, model 2031, New Focus, Calif., USA (4, 11); galvo-mirror QuantumScan5, Nuffield Technology Inc, N.H., USA (5, 8); paraboloidal mirror 02 POA 017, Melles Griot, Calif., USA (6, 7); plano-convex lens 01-LPX-336, plano-convex, 440 mm focal length, 145 mm diameter, Melles Griot, Calif., USA (9); PRESAGE™ radiochromic sample, Heuris Pharma LLC, Skilman, N.J. sitting on rotation stage PRS-110, PI miCos GmbH, Eschbach DE-79427 (10); PC, Intel Pentium with data acquisition system NI-PCI-6221, National Instruments, Dallas, Tex., USA (12); galvo mirror driver for Quantum Scan5, Nuffield Technology Inc, N.H., USA, coupled with home-built power supply (13). Optical distances are carefully specified: A 20 cm, B 30 cm, C 100 cm, D 44 cm, E 0.5 cm.

### Sample Data

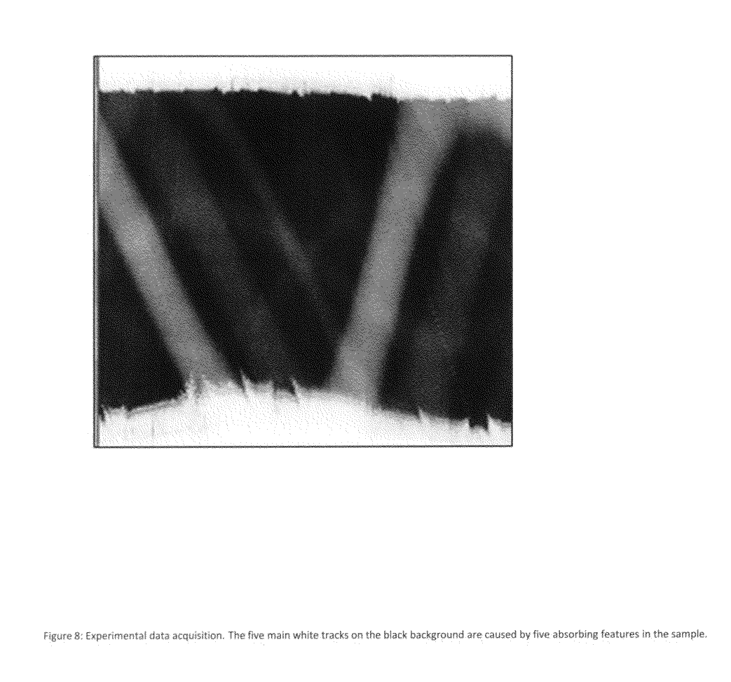

FIG. 8 illustrates experimental data acquired using the apparatus of Example 2, FIG. 5(b).

I claim:

1. An optical scanning system comprising a light source, a beam splitter, a reference detector, a transmitted light detector, a turntable actuated to rotate, and a computer program to store and evaluate data from the detector, wherein said program utilizes modified Algebraic Reconstruction Technique and wherein said scanning system does not include means of refractive index matching.

2. The system of claim 1 further comprising an irradiated dosimeter.

3. The system of claim 1 further comprising an irradiated shaped solid polymer dosimeter.

4. An optical scanning method comprising directing a light beam from a source to a beam splitter, splitting said light beam into a first and second split light beam, directing said first split light beam to a first detector, directing said second light beam through an object to a second detector, storing data from said first and second detectors in a computer, and evaluating said data by means of modified Algebraic Reconstruction Technique.

5. The method of claim 4 wherein the object is an irradiated dosimeter.

6. The method of claim 4 wherein the object is an irradiated shaped solid polymer dosimeter.

7. The method of claim 4 further comprising the production of a reconstructed three-dimensional image.

8. The method of claim 7 wherein the object is an irradiated dosimeter.

9. The method of claim 7 wherein the object is an irradiated shaped solid polymer dosimeter.
